(19) United States
(12) Patent Application Publication
(10) Pub. No.: US 2021/0224720 A1
(43) Pub. Date: Jul. 22, 2021

(54) INFORMATION PROCESSING APPARATUS, CONTROL METHOD, AND PROGRAM

(71) Applicant: NEC Corporation, Minato-ku, Tokyo (JP)

(72) Inventors: Kengo MAKINO, Tokyo (JP); Yusuke KIKUCHI, Tokyo (JP); Yukiko TANAKA, Tokyo (JP); Taichi TANAKA, Tokyo (JP); Daichi HASUMI, Tokyo (JP); Eiji YUMOTO, Tokyo (JP)

(73) Assignee: NEC Corporation, Minato-ku, Tokyo (JP)

(21) Appl. No.: 16/755,287

(22) PCT Filed: Oct. 4, 2018
(86) PCT No.: PCT/JP2018/037226

§ 371 Date: Apr. 10, 2020

(30) Foreign Application Priority Data
Oct. 19, 2017 (JP) 2017-202393

(51) Int. Cl. G06Q 10/06; G01P 15/08; G06Q 10/10

(52) U.S. Cl. CPC G06Q 10/063114; G06Q 10/109; G01P 15/08; G06Q 10/063116

(57) ABSTRACT

An information processing apparatus (2000) acquires state information representing states of persons, for a first person and a second person associated with the first person. The information processing apparatus (2000) determines whether a predetermined condition regarding states of the first person and the second person is satisfied, by using state information of the first person and state information of the second person. The information processing apparatus (2000) sends a notification of recommending at least the first person to take a break when the predetermined condition is satisfied.

### TECHNICAL FIELD

The present invention relates to an information processing apparatus, a control method, and a program.

### BACKGROUND ART

Systems for encouraging in-house communication have been developed. Patent Document 1, for example, discloses a system that, when one person is using a break room, notifies another person associated with the former person that the former person is staying in the break room.

### RELATED DOCUMENT

### Patent Document

[Patent Document 1] Japanese Patent Application Publication No. 2007-140801

### SUMMARY OF THE INVENTION

### Technical Problem

In the system disclosed in Patent Document 1, a notification is unconditionally sent to the latter person associated with the former person using the break room. Therefore, the notification may be sent even to an unsuitable person for taking a break.

The present invention has been made in consideration of the above-described problem, and has as its one object to provide a technique for appropriately creating an opportunity to allow a plurality of persons to take a break together.

### Solution to Problem

An information processing apparatus according to the present invention includes 1) a determination unit acquiring state information representing states of persons, for a first person and a second person associated with the first person in association information associating persons with each other, and determining whether a predetermined condition regarding states of the first person and the second person is satisfied, by using state information of the first person and state information of the second person, and 2) a notification unit sending a notification of recommending at least the first person to take a break when a predetermined condition regarding the first person and the second person is satisfied.

A control method according to the present invention is executed by a computer. The control method includes 1) a determination step of acquiring state information representing states of persons, for a first person and a second person associated with the first person in association information associating persons with each other, and determining whether a predetermined condition regarding states of the first person and the second person is satisfied, by using state information of the first person and state information of the second person, and 2) a notification step of sending a notification of recommending at least the first person to take a break when a predetermined condition regarding the first person and the second person is satisfied.

A program according to the present invention causes a computer to execute the steps of the control method according to the present invention.

### Advantageous Effects of Invention

The present invention provides a technique for appropriately creating an opportunity to allow a plurality of persons to take a break together.

### BRIEF DESCRIPTION OF THE DRAWINGS

The above and other objects, features, and advantages will be more apparent from the following description of preferred embodiments taken in conjunction with the following accompanying drawings.

FIG. 1 is a first diagram for explaining an overview of an information processing apparatus according to a first example embodiment.

FIG. 2 is a second diagram for explaining the overview of the information processing apparatus according to the first example embodiment.

FIG. 3 is a block diagram illustrating the functional configuration of the information processing apparatus according to the first example embodiment.

FIG. 4 is a block diagram illustrating a computer for implementing the information processing apparatus.

FIG. 5 is a diagram illustrating a drinking vessel.

FIG. 6 is a flowchart illustrating the sequence of processing performed by the information processing apparatus according to the first example embodiment.

FIG. 7 is a diagram illustrating association information in table form.

FIG. 8 is a block diagram illustrating the functional configuration of an information processing apparatus according to a second example embodiment.

FIG. 9 is a block diagram illustrating the functional configuration of an information processing apparatus according to a third example embodiment.

### DESCRIPTION OF EXAMPLE EMBODIMENTS

Example embodiments of the present invention will be described below with reference to the drawings. Note that in all the drawings, the same reference numerals denote the same components, and a description thereof will be omitted as appropriate. Unless otherwise specified, in each block diagram, the blocks do not represent hardware-specific configurations, but represent function-specific configurations.

### First Example Embodiment

<Overview>

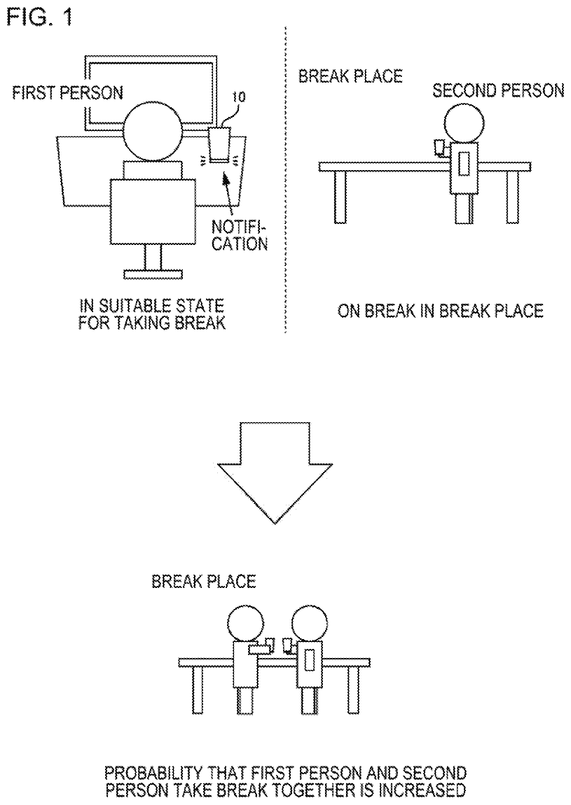

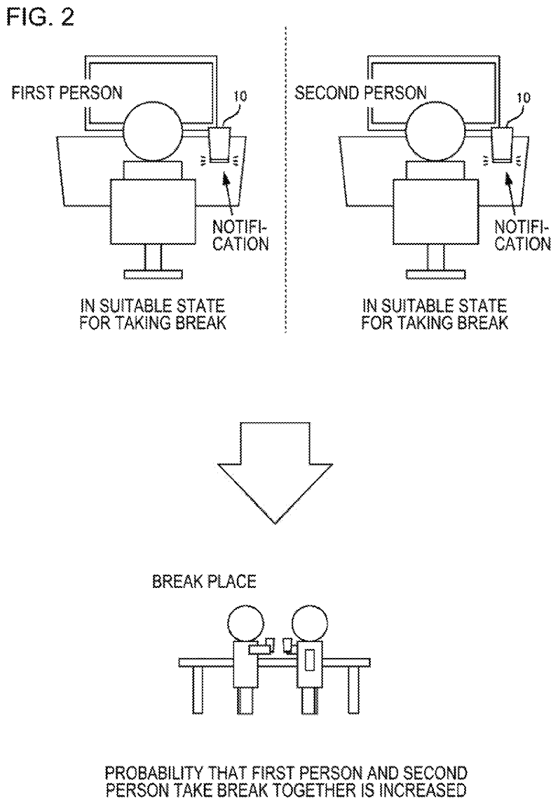

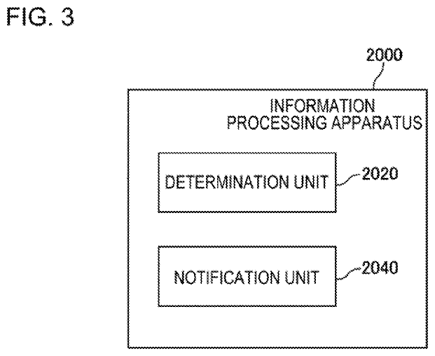

FIGS. 1 and 2 are diagrams for explaining an overview of an information processing apparatus (an information processing apparatus 2000 depicted in FIG. 3) according to a first example embodiment. The operation of the information processing apparatus 2000 to be described hereinafter is merely an example for facilitating an understanding of the information processing apparatus 2000, and the operation of the information processing apparatus 2000 is not limited to the following example. The details and variations of the operation of the information processing apparatus 2000 will be described later.

The information processing apparatus 2000 sends a notification (referred to as a break notification, hereinafter) to recommend a person at work to take a break, in order to create an opportunity to allow a plurality of persons to take a break together. In doing so, the information processing apparatus 2000 determines whether a break notification is to be sent to a person (referred to as a first person, hereinafter) who serves as a target for determination as to whether a break notification is to be sent, based on the state of the first person and the state of another person (referred to as a second person, hereinafter) associated with the first person in advance. Note that information representing association between the persons will be referred to as association information, hereinafter.

The information processing apparatus 2000 determines whether a predetermined condition regarding the first person and the second person is satisfied. As the predetermined condition, adoptable conditions may be (1) “the state of the first person is suitable for taking a break” and “the second person is staying in a break place,” or “the state of the first person is suitable for taking a break” and “the state of the second person is suitable for taking a break”. The information processing apparatus 2000 sends a break notification to at least the first person when the above-mentioned predetermined condition is satisfied.

In the example illustrated in FIG. 1, the first person is at work, and the second person is on his or her break in a break place. In view of this, the information processing apparatus 2000 sends a break notification to the first person when the state of the first person is suitable for taking a break. On the other hand, in the second example, both the first person and the second person are at work. Therefore, the information processing apparatus 2000 sends a break notification to both the first person and the second person when both of them are at an appropriate timing to take a break. Note that in both of FIGS. 1 and 2, a break notification is sent by turning on lamps mounted on drinking vessels used by the persons.

As the predetermined condition, one of (1) and (2) may be adopted, or both (1) and (2) may be adopted. In the latter case, as long as one of conditions (1) and (2) is satisfied, the predetermined condition is satisfied. In other words, as long as the first person is in a suitable state for taking a break, and the second person is in a suitable state for taking a break or is staying in a break place, the predetermined condition is satisfied. Note that, although details will be described later, the condition in which the state of a certain person is suitable for taking a break is satisfied in, for example, the state in which the remaining amount of beverage contained in a drinking vessel 10 is small, that in which the concentration of this person has dropped, or that in which the degree of fatigue of this person is high.

The state of the first person and that of the second person are recognized using state information of each person. The state information means information representing the state of a person. The details of the state information will be described later.

### Advantageous Effect

The information processing apparatus 2000 according to this example embodiment determines whether the state of a first person and the state of a second person satisfies the predetermined condition, the first person serving as a target for determination as to whether a recommendation to take a break is to be issued, and the second person being associated with the first person. Then, a break notification is sent to the first person when the predetermined condition is satisfied. Note that as the predetermined condition, adoptable conditions may be (1) “the state of the first person is suitable for taking a break” and “the second person is staying in a break place,” or the condition “the state of the first person is suitable for taking a break” and “the state of the second person is suitable for taking a break”. By sending a break notification in such a situation, the information processing apparatus 2000 can increase the probability that the first person and the second person will take a break together. Hence, associating persons desired to take a break together with each other using association information makes it possible to enhance the probability that the persons desired to take a break together will take a break together.

With the above-mentioned method, a break notification is sent to a person when the state of the person is suitable for taking a break. This makes it possible to prevent an unsuitable person for taking a break (for example, a person who has been able to concentrate considerably on his or her work and is thus desired to continue this work) from being recommended to take a break. This, in turn, makes it possible to increase the probability that persons desired to take a break together will take a break together, without hindering the work of each person.

The information processing apparatus 2000 according to this example embodiment will be described in more detail below.

<Exemplary Functional Configuration of Information Processing Apparatus 2000>

FIG. 3 is a block diagram illustrating the functional configuration of the information processing apparatus 2000 according to the first example embodiment. The information processing apparatus 2000 includes a determination unit 2020 and a notification unit 2040. The determination unit 2020 acquires state information of a first person and a second person, and determines, using the acquired state information, whether a predetermined condition regarding the states of the first person and the second person is satisfied. The notification unit 2040 sends a break notification to at least the first person when the predetermined condition is satisfied.

<Hardware Configuration of Information Processing Apparatus 2000>

Each functional configuration unit of the information processing apparatus 2000 may be implemented as hardware (for example, a hard-wired electronic circuit) for implementing this functional configuration unit, or may be implemented as a combination of hardware and software (for example, a combination of an electronic circuit and a program for controlling it). The case where each functional configuration unit of the information processing apparatus 2000 is implemented as a combination of hardware and software will further be described below.

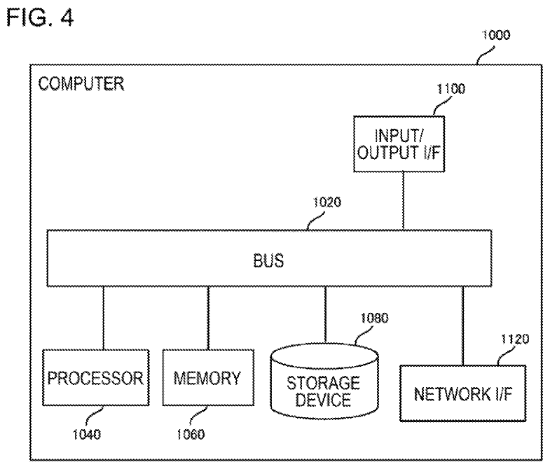

FIG. 4 is a block diagram illustrating a computer 1000 for implementing the information processing apparatus 2000. The computer 1000 is implemented as an arbitrary computer. Examples of the computer 1000 include a personal computer (PC), a server machine, a tablet terminal, and a smartphone. The computer 1000 may be implemented as a general-purpose computer or a dedicated computer designed to implement the information processing apparatus 2000.

The computer 1000 includes a bus 1020, a processor 1040, a memory 1060, a storage device 1080, an input/output interface 1100, and a network interface 1120. The bus 1020 serves as a data transmission line for allowing the processor 1040, the memory 1060, the storage device 1080, the input/output interface 1100, and the network interface 1120 to exchange data with each other. The method for connecting the processor 1040 and the like to each other, however, is not limited to bus connection. The processor 1040 includes various processors such as a central processing unit (CPU), a graphics processing unit (GPU), or a field-programmable gate array (FPGA). The memory 1060 serves as a main storage device implemented using, for example, a random access memory (RAM). The storage device 1080 serves as an auxiliary storage device implemented using, for example, a hard disk, a solid state drive (SSD), a memory card, or a read only memory (ROM).

The input/output interface 1100 is used to connect the computer 1000 to an input/output device. An input device such as a keyboard and an output device such as a display device, for example, are connected to the input/output interface 1100.

The network interface 1120 is used to connect the computer 1000 to a network. Examples of the communication network include a local area network (LAN) and a wide area network (WAN). The method for connection to the network by the network interface 1120 may be either wireless or wired connection.

The storage device 1080 stores a program module for implementing each functional configuration unit of the information processing apparatus 2000. The processor 1040 implements a function corresponding to each program module by reading these program modules into the memory 1060 and executing them.

<Details of Drinking Vessel 10>

The drinking vessel 10 may be used for the operation of the information processing apparatus 2000. An example of the drinking vessel 10 is a tumbler. Referring, for example, to FIG. 1, the drinking vessel 10 is used to send a break notification. The drinking vessel 10 may further be used to, for example, recognize the state of a person. The drinking vessel 10, however, is not indispensable to implement the information processing apparatus 2000.

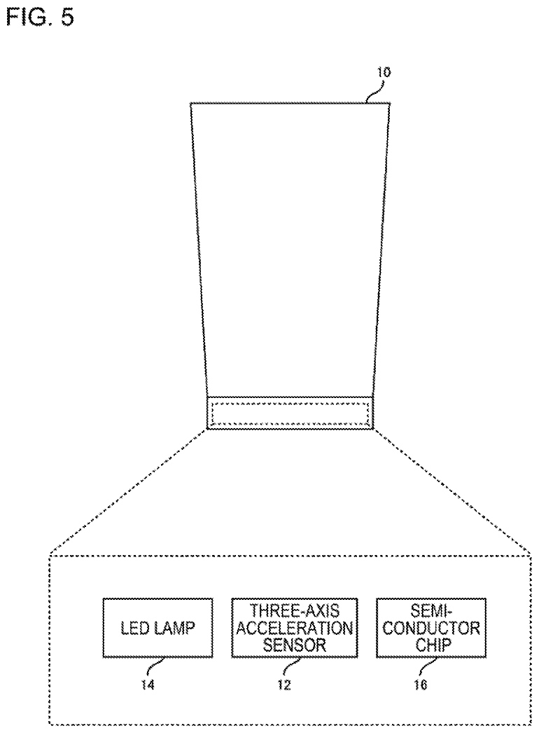

FIG. 5 is a diagram illustrating the drinking vessel 10. The drinking vessel 10 illustrated in FIG. 5 is equipped with a three-axis acceleration sensor 12, an LED lamp 14, and a semiconductor chip 16. The three-axis acceleration sensor 12 is used to detect the tilt of the drinking vessel 10. The tilt of the drinking vessel 10 can be used to estimate the remaining amount of beverage in the drinking vessel 10, as will be described later. The LED lamp 14 is used to send a break notification. The semiconductor chip 16 serves as a computer for controlling the three-axis acceleration sensor 12 and the LED lamp 14. The semiconductor chip 16, for example, acquires a value detected by the three-axis acceleration sensor from this sensor, transmits it to the information processing apparatus 2000, receives an instruction from the information processing apparatus 2000, and turns on the LED lamp 14 in accordance with the instruction. Note that the method for sending a break notification using the drinking vessel 10 is not limited to such a method for turning on a lamp, as will be described later.

<Sequence of Processing>

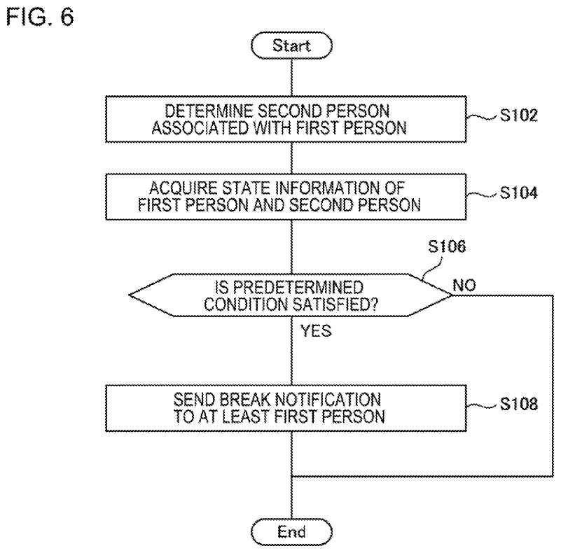

FIG. 6 is a flowchart illustrating the sequence of processing performed by the information processing apparatus 2000 according to the first example embodiment. The determination unit 2020 determines a second person associated with a first person in association information (S102). The determination unit 2020 acquires state information of the first person and the second person (S104). The determination unit 2020 determines whether a predetermined condition is satisfied, using the state information of the first person and the second person (S106). If the predetermined condition is satisfied (YES in step S106), the notification unit 2040 sends a break notification to at least the first person (S108). On the other hand, if the predetermined condition is not satisfied (NO in step S106), the processing illustrated in FIG. 6 ends.

<<Timing to Perform Series of Processes>>

The series of processes illustrated in FIG. 6 may be performed at various timings. The information processing apparatus 2000, for example, periodically handles each person as a first person, and determines whether a break notification is to be sent to this person. In doing so, each person may be handled as a first person in various orders. The information processing apparatus 2000, for example, randomly determines persons to be handled as first persons. As another example, respective associations indicated by the association information may be assigned with priority level, and persons indicated by these associations may be handled as first persons in descending order of the priority level. In this case, the information processing apparatus 2000 handles one of two persons associated with each other in the association information as a first person, and handles the other person as a second person.

As still another example, the information processing apparatus 2000 may perform the above-mentioned series of processes in response to a predetermined notification from a terminal installed around each person. For example, a terminal associated with a certain person periodically determines whether the state of this person is suitable for taking a break. When the state of this person is suitable for taking a break, the terminal notifies the information processing apparatus 2000. In response to this notification, the information processing apparatus 2000 handles the person associated with the terminal having sent the notification as a first person, and determines whether a break notification is to be sent to this person. Examples of the terminal associated with the person include a PC and a portable terminal belonging to this person, a wearable terminal carried on by this person, and a drinking vessel 10 belonging to this person. Note that information associating the person and the terminal with each other is stored in advance in a storage device accessible from the information processing apparatus 2000.

<Determination of Second Person: S102>

The determination unit 2020 determines a second person associated with a first person, using association information (S102). The association information is preliminarily stored in a storage device accessible from the determination unit 2020.

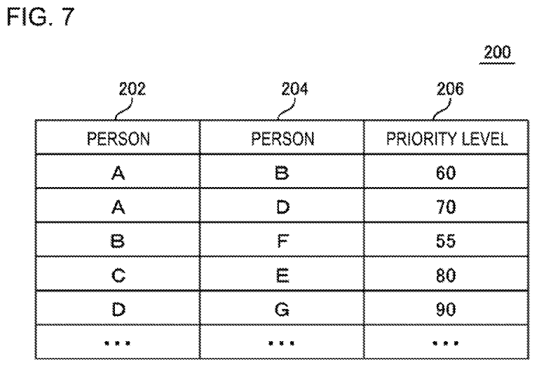

FIG. 7 is a diagram illustrating association information in table form. The table illustrated in FIG. 7 will be referred to as a table 200 hereinafter. The table 200 includes the columns of Person 202, Person 204, and Priority Level 206. Person 202 and Person 204 individually indicate the identifiers of persons. Each record of the table 200 associates a person determined by the identifier indicated by Person 202 with a person determined by the identifier indicated by Person 204.

Priority Level 206 indicates the priority level of association. A method for using the priority level will be described later. The priority level may be manually set, or may be automatically set by the information processing apparatus 2000. A method for automatically setting the priority level will be described in the second example embodiment. Note that, when the priority level is not used, the table 200 may not include the Priority level 206.

Assume herein that a plurality of persons associated with a first person exist. In this case, the determination unit 2020, for example, determines whether a predetermined condition is satisfied for the first person and a second person, while sequentially changing the person to be handed as the second person. In the example illustrated in, for example, FIG. 7, persons B and D are associated with person A. When, therefore, person A is handled as a first person, the determination unit 2020 sequentially handles persons B and D as second persons.

When a plurality of persons are handled as second persons, a variety of methods are available to determine the order of this handling. The determination unit 2020, for example, sequentially refers to the association information from the top. In other words, persons associated with a first person in the association information are sequentially handled as second persons from the top. In the example illustrated in, for example, FIG. 7, when person A is handled as a first person, person B is handled as a second person first, and then person D is handled as a second person.

As another example, the determination unit 2020 may handle persons associated with a first person as second persons in descending order of priority level of association with the first person. In the example illustrated in, for example, FIG. 7, the priority level of association between persons A and B is 60, while that between persons A and D is 70; the latter priority level is higher. In view of this, when person A is handled as the first person, the determination unit 2020 handles person D as the second person first, and then handles person B as the second person.

<Details of State Information: S104>

The determination unit 2020 acquires state information for the first person and the second person (S104). The state information is used in processing for determining whether the state of the first person or the second person is suitable for taking a break, and processing for determining whether the second person is staying in a break place. The state information will be described below for various states.

<<State Information for Determining Whether State of Person Is Suitable for Taking Break>>

This state information indicates index values for various determination indices that can be used to determine whether the state of a person is suitable for taking a break. Several determination indices will be taken as an example below.

<<<Remaining Amount of Beverage>>>

An example of the determination index is information that allows estimation of the remaining amount of beverage in a drinking vessel 10 used by the person. The state in which the remaining amount of beverage is small can be said to be an appropriate timing to replenish a drink. The appropriate timing to replenish a drink can, in turn, be said to be an appropriate timing to take a break. Therefore, the remaining amount of beverage that the person is drinking can be used as an index for determining whether the state of the person is suitable for taking a break.

The remaining amount of beverage can be determined based, for example, on a change in tilt of the drinking vessel 10. When only a small amount of beverage is contained in the drinking vessel 10, the drinking vessel 10 is considerably tilted upon drinking of the beverage. Thus, the remaining amount of beverage can be estimated based on the degree of tilt of the drinking vessel 10. The tilt of the drinking vessel 10 can be determined based, for example, on the above-mentioned value detected by the three-axis acceleration sensor 12.

<<<Temperature>>>

Another example of the determination index is the temperature in the environment surrounding the person. Since the person is likely to suffer a drop in concentration or accumulation of fatigue in the state in which the temperature in the environment surrounding the person is not within an appropriate temperature range (it is too cold or too hot) or in which the temperature considerably fluctuates, these states are considered to be suitable for taking a break (a state in which the person is to take a break). Thus, the temperature in the environment surrounding the person can be used as an index for determining whether the state of the person is suitable for taking a break. Note that the temperature in the environment surrounding the person can be determined based, for example, on a value detected by a temperature sensor installed on the periphery of the person.

<<<Humidity>>>

Still another example of the determination index is the humidity in the environment surrounding the person. Since the person is likely to suffer a drop in concentration or accumulation of fatigue in the state in which the humidity in the environment surrounding the person is not within an appropriate humidity range (the humidity is too high or too low) or in which the humidity considerably fluctuates, these states are considered to be suitable for taking a break (a state in which the person is to take a break). Thus, the humidity in the environment surrounding the person can be used as an index for determining whether the state of the person is suitable for taking a break. Note that the humidity in the environment surrounding the person can be determined based on a value detected by a humidity sensor installed on the periphery of the person.

<<<Concentration of Carbon Dioxide>>>

Still another example of the determination index is the concentration of carbon dioxide in the environment surrounding the person. Since the person is likely to get sleepy in the state in which the concentration of carbon dioxide is high, this state is considered to be suitable for taking a break (a state in which the person is to take a break). Thus, the concentration of carbon dioxide in the environment surrounding the person can be used as an index for determining whether the state of the person is suitable for taking a break. Note that the concentration of carbon dioxide in the environment surrounding the person can be determined based on a value detected by a carbon dioxide concentration sensor installed on the periphery of the person.

<<<Atmospheric Pressure>>>

Still another example of the determination index is the atmospheric pressure in the environment surrounding the person. Since the person is likely to have a headache in the state in which the atmospheric pressure is low, this state is considered to be suitable for taking a break (a state in which the person is to take a break). Thus, the atmospheric pressure in the environment surrounding the person can be used as an index for determining whether the state of the person is suitable for taking a break. Note that the atmospheric pressure in the environment surrounding the person can be determined based on a value detected by an atmospheric pressure sensor installed on the periphery of the person.

<<<Sound Pressure>>>

Still another example of the determination index is the sound pressure in the environment surrounding the person. Since the person can hardly concentrate in the state in which the sound pressure is high (the state in which the surrounding environment is noisy) or in which the sound pressure considerably fluctuates (for example, that in which the surrounding environment suddenly gets noisy, or loud sounds are intermittently produced), these states are considered to be suitable for taking a break (a state in which the person is to take a break). Thus, the sound pressure in the environment surrounding the person can be used as an index for determining whether the state of the person is suitable for taking a break. Note that the sound pressure in the environment surrounding the person can be determined based on a value detected by a sound pressure sensor installed on the periphery of the person.

<<<Illuminance>>>

Still another example of the determination index is the illuminance in the environment surrounding the person. In the state in which the illuminance in the surrounding environment is low, that is, the state in which the surrounding environment is dark, the person can hardly concentrate mentally, because he or she may get depressed or the like. The state in which the illuminance in the surrounding environment considerably fluctuates is also considered to be an unsuitable state for concentration. Thus, these states are suitable for taking a break (a state in which the person is to take a break). Thus, the illuminance in the environment surrounding the person can be used as an index for determining whether the state of the person is suitable for taking a break. Note that the illuminance in the environment surrounding the person can be determined based on a value detected by an illuminance sensor installed on the periphery of the person.

<<<Operation Speed of Device>>>

Still another example of the determination index is the speed at which the person operates an input device (for example, a keyboard, a mouse, or a touch panel). When concentration drops or fatigue accumulates, the operation speed of the input device lowers. The state in which the operation speed of the input device lowers is considered to be suitable for taking a break (a state in which the person is to take a break). Thus, the change in operation speed of the input device can be used as an index for determining whether the state of the person is suitable for taking a break. Note that the operation speed of the input device can be acquired from, for example, an operating system (OS) running on a computer (for example, a PC that the person uses for work) operated by the input device.

<<<Time Having Elapsed After Previous Break>>>

Still another example of the determination index is the time having elapsed after the person took a break last time. This time can also be interpreted as the duration of the person's work. The longer the duration of the work, the more fatigue may accumulate, and resulting in lower concentration. Thus, the time having elapsed after the person took a break last time can be used as an index for determining whether the state of the person is suitable for taking a break.

<<<Biometric Information>>>

Still another example of the determination index is biometric information such as the pulse rate or the blood flow rate of the person. The biometric information such as the pulse rate or the blood flow rate is known as being available to estimate the degree of fatigue. In the state, for example, in which the pulse rate is high or in which the blood flow rate is low, the degree of fatigue is considered to be high. Thus, these types of biometric information can be used as indices for determining whether the state of the person is suitable for taking a break. Note that the pulse rate and the blood flow rate can be determined based on values detected by a pulse sensor and a blood flow sensor, respectively. These sensors are installed on, for example, a wearable device (for example, a wristwatch device) carried on by a user.

<<<Schedule Information>>>

Still another example of the determination index is the schedule of the person. Compared to the time in which an event that hampers a break (for example, a conference) is scheduled, the state of the person is considered to be likely to be suitable during the time in which such the event is not scheduled. Thus, the schedule can be used as an index for determining whether the state of the person is suitable for taking a break. Note that the schedule of the person can be recognized by acquiring schedule information representing the schedule of the person from, for example, a schedule management system that manages the schedule of each person.

<<State Information for Determining Whether Person is Staying in Break Place>>

Various types of information are available to determine whether a person is staying in a break place. Assume, for example, that the location of each person is managed by performing entrance and exit management in each room of an office including a break room. In this case, the determination unit 2020 can determine whether a second person is staying in the break place, by acquiring information representing the location of the second person as state information.

As another example, the determination unit 2020 may acquire position information of a terminal belonging to a second person as state information. Examples of the terminal belonging to the second person include a drinking vessel 10 and a portable terminal. These terminals are equipped with global positioning system (GPS) sensors.

As still another example, a terminal (referred to as a radio wave reception terminal, hereinafter) that receives radio waves from a terminal belonging to a second person may be set in a break place. An example of the radio wave reception terminal is an access point for a wireless local area network (LAN). The terminal belonging to the second person has the function of transmitting data to the radio reception terminal by carrying the data on radio waves. When, for example, the terminal belonging to the second person performs communication via the wireless LAN, a network interface for connection to a radio channel is mounted on this terminal, and radio waves carrying the data are transmitted from the network interface. Examples of the terminal belonging to the second person include a drinking vessel 10 and a portable terminal.

Under such an environment, the closer the second person is to the break place, the higher the intensity of radio waves received from the terminal of the second person by the radio wave reception terminal may be. In view of this, for example, the radio wave reception terminal generates state information indicating the intensity of radio waves received from a terminal belonging to a person, in association with the identifier (for example, the MAC address) of the terminal. The determination unit 2020 acquires the state information of the second person generated by the radio wave reception terminal. In other words, the radio wave reception terminal receives information indicating the intensity of radio waves received from the terminal of the second person. The determination unit 2020 determines whether the second person is staying in the break place, by determining, using the received state information, whether the intensity of radio waves received from the terminal of the second person by the radio wave reception terminal is high. When, for example, the radio wave intensity is equal to or higher than a predetermined value, it is determined that the second person is staying in the break place.

State information based on the radio wave intensity may even be generated by the terminal of the second person. A terminal that performs wireless communication generally includes the function of receiving radio waves from an access point and recognizing the access point. The terminal also includes the function of recognizing the intensity of radio waves received from the access point in this operation. In view of this, a terminal (referred to as a radio wave transmission terminal, hereinafter) that transmits radio waves, such as an access point for a wireless LAN, is set in a break place. The terminal of the second person then generates state information associating with each other the intensity of received radio waves and the identifier of the radio wave transmission terminal (for example, the service set identifier (SSID)) having transmitted the radio waves.

Under such an environment, the closer the second person is to the break place, the higher the intensity of radio waves received from the radio wave transmission terminal by the terminal of the second person may be. In view of this, the determination unit 2020 determines whether the second person is staying in the break place, by acquiring the state information generated by the terminal of the second person, and determining whether the radio wave intensity indicated by the state information is high (for example, whether this intensity is equal to or higher than a predetermined value). When, for example, the radio wave intensity is equal to or higher than a predetermined value, it is determined that the second person is staying in the break place.

<<Method for Acquiring State Information>>

A variety of methods are available to acquire state information by the determination unit 2020. The determination unit 2020, for example, acquires state information by receiving state information transmitted from a device having generated the state information. As another example, the determination unit 2020 may acquire state information by accessing a device having generated the state information. A device having generated state information may even store the state information in a storage device accessible from the determination unit 2020. In this case, the determination unit 2020 acquires the state information by accessing the storage device.

<Determination as to Whether Predetermined Condition Is Satisfied: S106>

The determination unit 2020 determines whether a predetermined condition is satisfied, using the state information of the first person and the second person (S106). As described earlier, the predetermined condition is defined as condition (1) “the state of the first person is suitable for taking a break” and “the second person is staying in a break place,” or condition (2) “the state of the first person is suitable for taking a break” and “the state of the second person is suitable for taking a break.” In view of this, a method for determining whether the state of a person is suitable for taking a break, and a method for determining whether a person is staying in a break place will be individually described below.

<<Method for Determining Whether State of Person is Suitable for Taking Break>>

The above-mentioned various determination indices are available to determine whether the state of a person is suitable for taking a break. The determination unit 2020 determines whether the state of the person is suitable for taking a break, using state information indicating one or more determination indices.

Assume, for example, that the remaining amount of beverage in a drinking vessel 10 used by the person is used as a determination index. In this case, the determination unit 2020 determines whether the estimated remaining amount of beverage is small, and further determines that the state of the person is suitable for taking a break when this remaining amount of beverage is small. More specifically, the determination unit 2020 determines that the state of the person is suitable for taking a break when the statistic (for example, the maximum value or the average) of the tilt of the drinking vessel 10 is equal to or larger than a predetermined value. On the other hand, the determination unit 2020 determines that the state of the person is unsuitable for taking a break when this statistic is smaller than the predetermined value.

The determination unit 2020 may even use, as an index value, the length of the time having elapsed after the remaining amount of beverage in the drinking vessel 10 becomes small. This is because, the longer the time having elapsed after the remaining amount of beverage in the drinking vessel 10 becomes small, the higher the probability that the person who uses the drinking vessel 10 will want to take a break to pour a drink. In view of this, for example, the determination unit 2020 computes the time having elapsed after the estimated value of the remaining amount of beverage in the drinking vessel 10 becomes equal to or smaller than a predetermined value, and determines that the person is suitable for taking a break when this elapsed time is equal to or longer than a predetermined value. On the other hand, the determination unit 2020 determines that the person is unsuitable for taking a break when this elapsed time is shorter than the predetermined value.

Assume, as another example, that the temperature in the environment surrounding the person is used as a determination index. In this case, the determination unit 2020, for example, determines whether the temperature in the environment surrounding the person is within a predetermined range. The determination unit 2020 determines that the state of the person is suitable for taking a break when the temperature in the environment surrounding the person is not within the predetermined range. On the other hand, the determination unit 2020 determines that the state of the person is unsuitable for taking a break when the temperature in the environment surrounding the person is within the predetermined range.

Assume, as still another example, that the magnitude of a change in temperature in the environment surrounding the person is used as a determination index. In this case, the determination unit 2020, for example, determines whether the magnitude of a change in temperature in the environment surrounding the person is equal to or larger than a predetermined value. The determination unit 2020 determines that the state of the person is suitable for taking a break when the magnitude of the change in temperature in the environment surrounding the person is equal to or larger than the predetermined value. On the other hand, the determination unit 2020 determines that the state of the person is unsuitable for taking a break when the magnitude of the change in temperature in the environment surrounding the person is smaller than the predetermined value. Note that the magnitude of the change in value can be represented by a statistic such as variance or standard deviation.

Assume, as still another example, that the humidity in the environment surrounding the person is used as a determination index. In this case, the determination unit 2020, for example, determines whether the humidity in the environment surrounding the person is within a predetermined range. The determination unit 2020 determines that the state of the person is suitable for taking a break when the humidity in the environment surrounding the person is not within the predetermined range. On the other hand, the determination unit 2020 determines that the state of the person is unsuitable for taking a break when the humidity in the environment surrounding the person is within the predetermined range.

Assume, as still another example, that the magnitude of a change in humidity in the environment surrounding the person is used as a determination index. In this case, the determination unit 2020, for example, determines whether the magnitude of a change in humidity in the environment surrounding the person is equal to or larger than a predetermined value. The determination unit 2020 determines that the state of the person is suitable for taking a break when the magnitude of the change in humidity in the environment surrounding the person is equal to or larger than the predetermined value. On the other hand, the determination unit 2020 determines that the state of the person is unsuitable for taking a break when the magnitude of the change in humidity in the environment surrounding the person is smaller than the predetermined value.

Assume, as still another example, that the concentration of carbon dioxide in the environment surrounding the person is used as a determination index. In this case, the determination unit 2020, for example, determines whether the concentration of carbon dioxide in the environment surrounding the person is equal to or higher than a predetermined value. The determination unit 2020 determines that the state of the person is suitable for taking a break when the concentration of carbon dioxide in the environment surrounding the person is equal to or higher than the predetermined value. On the other hand, the determination unit 2020 determines that the state of the person is unsuitable for taking a break when the concentration of carbon dioxide in the environment surrounding the person is lower than the predetermined value.

Assume, as still another example, that the atmospheric pressure in the environment surrounding the person is used as a determination index. In this case, the determination unit 2020, for example, determines whether the atmospheric pressure in the environment surrounding the person is equal to or lower than a predetermined value. The determination unit 2020 determines that the state of the person is suitable for taking a break when the atmospheric pressure in the environment surrounding the person is equal to or lower than the predetermined value. On the other hand, the determination unit 2020 determines that the state of the person is unsuitable for taking a break when the atmospheric pressure in the environment surrounding the person is higher than the predetermined value.

Assume, as still another example, that the sound pressure in the environment surrounding the person is used as a determination index. In this case, the determination unit 2020, for example, determines whether the sound pressure in the environment surrounding the person is equal to or higher than a predetermined value. The determination unit 2020 determines that the state of the person is suitable for taking a break when the sound pressure in the environment surrounding the person is equal to or higher than the predetermined value. On the other hand, the determination unit 2020 determines that the state of the person is unsuitable for taking a break when the sound pressure in the environment surrounding the person is lower than the predetermined value.

Assume, as still another example, that the magnitude of a change in sound pressure in the environment surrounding the person is used as a determination index. In this case, the determination unit 2020 determines whether the magnitude of a change in sound pressure in the environment surrounding the person is equal to or larger than a predetermined value. The determination unit 2020 determines that the state of the person is suitable for taking a break when the magnitude of the change in sound pressure in the environment surrounding the person is equal to or larger than the predetermined value. On the other hand, the determination unit 2020 determines that the state of the person is unsuitable for taking a break when the magnitude of the change in sound pressure in the environment surrounding the person is smaller than the predetermined value.

Assume, as still another example, that the illuminance in the environment surrounding the person is used as a determination index. In this case, the determination unit 2020, for example, determines whether the illuminance in the environment surrounding the person is equal to or lower than a predetermined value. The determination unit 2020 determines that the state of the person is suitable for taking a break when the illuminance in the environment surrounding the person is equal to or lower than the predetermined value. On the other hand, the determination unit 2020 determines that the state of the person is unsuitable for taking a break when the illuminance in the environment surrounding the person is higher than the predetermined value.

Assume, as still another example, that the magnitude of a change in illuminance in the environment surrounding the person is used as a determination index. In this case, the determination unit 2020 determines whether the magnitude of a change in illuminance in the environment surrounding the person is equal to or larger than a predetermined value. The determination unit 2020 determines that the state of the person is suitable for taking a break when the magnitude of the change in illuminance in the environment surrounding the person is equal to or larger than the predetermined value. On the other hand, the determination unit 2020 determines that the state of the person is unsuitable for taking a break when the magnitude of the change in illuminance in the environment surrounding the person is smaller than the predetermined value.

Assume, as still another example, that the speed at which the person operates an input device is used as a determination index. In this case, the determination unit 2020 determines whether the speed at which the person operates an input device is significantly lower than a normal speed. The determination unit 2020 determines that the state of the person is suitable for taking a break when the speed at which the person operates the input device is significantly lower than the normal speed. On the other hand, the determination unit 2020 determines that the state of the person is unsuitable for taking a break when the speed at which the person operates the input device is not significantly lower than the normal speed.

That “the speed at which the person operates the input device is significantly lower than the normal speed” unit example, that the ratio between the current value and the normal value of the speed at which the person operates the input device is equal to or lower than a predetermined value. The normal value of the speed at which the person operates the input device is, for example, stored in a storage device in advance. As another example, the normal value of the speed at which a certain person operates the input device may be defined by, for example, the average, the maximum value, the mode, or the median of the speed at which this person operates the input device.

Assume, as still another example, that the time having elapsed after the person took a break last time is used as a determination index. In this case, the determination unit 2020, for example, determines whether the time having elapsed after the person took a break last time is equal to or longer than a predetermined value. The determination unit 2020 determines that the state of the person is suitable for taking a break when this elapsed time is equal to or longer than the predetermined value. On the other hand, the determination unit 2020 determines that the state of the person is unsuitable for taking a break when this elapsed time is shorter than the predetermined value.

Assume, as still another example, that the pulse rate is used as a determination index. In this case, the determination unit 2020, for example, determines whether the pulse rate of the person is equal to or higher than a predetermined value. The determination unit 2020 determines that the state of the person is suitable for taking a break when the pulse rate of the person is equal to or higher than the predetermined value. On the other hand, the determination unit 2020 determines that the state of the person is unsuitable for taking a break when the pulse rate of the person is lower than the predetermined value.

Assume, as still another example, that the blood flow rate is used as a determination index. In this case, the determination unit 2020, for example, determines whether the blood flow rate of the person is equal to or lower than a predetermined value. The determination unit 2020 determines that the state of the person is suitable for taking a break when the blood flow rate of the person is equal to or lower than the predetermined value. On the other hand, the determination unit 2020 determines that the state of the person is unsuitable for taking a break when the blood flow rate of the person is higher than the predetermined value.

Assume, as still another example, that the schedule is used as a determination index. In this case, the determination unit 2020, for example, determines whether a predetermined event is scheduled at the current time in the schedule information of the person. The determination unit 2020 determines that the state of the person is suitable for taking a break when the predetermined event is not scheduled. On the other hand, the determination unit 2020 determines that the state of the person is suitable for taking a break when the predetermined event is scheduled.

Note that the “predetermined event scheduled” may be an arbitrary event scheduled, or may be limited to a specific event scheduled. In the former case, in the schedule information of the person, it is determined that the state of the person is suitable for taking a break when no event is scheduled at the current time, and it is determined that the state of the person is unsuitable for taking a break when any event is scheduled at the current time.

On the other hand, when the “predetermined event scheduled” is limited to a specific one, even if a certain event is scheduled at the current time, it is determined that the state of the person is suitable for taking a break as long as this event is different from the specific event scheduled. As the specific event scheduled, a “conference,” for example, is set. In this case, in the schedule information of the person, when no event is scheduled at the current time, or an event other than the conference is scheduled at the current time, it is determined that the state of the person is suitable for taking a break. On the other hand, when the “conference” event is scheduled at the current time, it is determined that the state of the person is unsuitable for taking a break.

Note that, in comparing the index value of each of the above-mentioned indices with a predetermined value, one index value may be compared with the predetermined value, or the statistic of a plurality of index values may be compared with the predetermined value. In the latter case, in, for example, determining whether the temperature in the environment surrounding the person is within a predetermined range, the determination unit 2020 compares the statistic of a plurality of temperatures detected by a temperature sensor with a predetermined value.

<<<Case where Plurality of Determination Indices are Used>>>

The determination unit 2020 may perform determination using a plurality of determination indices among the above-mentioned determination indices. The determination unit 2020, for example, performs the above-mentioned determination for each determination index, and determines that the state of the person is suitable for taking a break when it is determined that “the state of the person is suitable for taking a break” for a predetermined number of determination indices or more.

As another example, the determination unit 2020 may compute a score representing the extent to which the state of the person is suitable for taking a break, using a plurality of determination indices. In this case, the determination unit 2020 determines that the state of the person is suitable for taking a break when the score is equal to or greater than a predetermined value. Furthermore, in determining whether the states of both the first person and the second person are suitable for taking a break, the determination unit 2020 may compute the product of the score computed for the first person and the score computed for the second person, and compare this product with a predetermined value. In other words, it is determined that the states of both the first person and the second person are suitable for taking a break when this product is equal to or larger than the predetermined value.

As the score, the discomfort index computed using temperature and humidity, or the difference between the outdoor air temperature and the temperature in the environment surrounding the person, for example, can be used. The score, however, is not limited to these examples. The score can be defined as, for example, a value (for example, a weighted average) obtained by statistically processing a plurality of determination indices. The weight applied to each determination index may be manually set, or may be set by the information processing apparatus 2000. In the latter case, for example, the weight of each determination index may be determined using machine learning. More specifically, the information processing apparatus 2000 generates and updates a score computation equation (an estimation model for estimating whether the state of the person is suitable for taking a break) by performing machine learning using a combination of the value of each determination index and correct answer data.

Note that an estimation model may be commonly generated for all persons, or may be generated for each individual person. In the latter case, the information processing apparatus 2000 generates an estimation model by acquiring, for each person, the value of any determination index and correct answer data. As another example, a questionnaire may be conducted for each person to survey the occasions on which he or she suffers a drop in concentration, feels fatigued, or the like, and an estimation model may be generated specially for this person, using the questionnaire result. Assume, for example, that the questionnaire result of a certain person reveals that this person cannot concentrate when his or her surrounding environment is dark, but the same person can concentrate even when his or her surrounding environment is noisy. In this case, in the estimation model used specially for this person, the illuminance is heavily weighted, and the sound pressure is lightly weighted.

The estimation model generated for each individual person is stored in a storage device in association with the identifier of this person. In determining whether the state of a certain person is suitable for taking a break, the determination unit 2020 acquires the estimation model stored in association with the identifier of this person, and determines whether the state of this person is suitable for taking a break, using the estimation model.

<Details of Break Notification: S108>

The notification unit 2040 sends a break notification to the first person (S108). More specifically, the notification unit 2040 transmits a break notification to a terminal associated with the first person. Examples of the terminal associated with the first person include a PC and a portable terminal belonging to this person. The break notification in this case is implemented as, for example, an e-mail message or a message communicated via an in-house chat tool. The break notification preferably includes information (for example, a name) capable of identifying the second person. When the second person is staying in a break place, the break notification preferably includes information (for example, a location or a name) capable of identifying the break place.

Another example of the terminal associated with the first person is the drinking vessel 10 of the first person. In this case, the notification unit 2040 transmits an instruction to the semiconductor chip 16 mounted on the drinking vessel 10 to send a break notification. In response to the instruction, the semiconductor chip 16 sends a break notification using an electronic device mounted on the drinking vessel 10.

A lamp such as the LED lamp 14, or a display device, for example, is mounted on the drinking vessel 10. The semiconductor chip 16 turns on the lamp or displays a message on the display device, in response to the instruction from the information processing apparatus 2000. The message to be displayed on the display device preferably includes information capable of identifying the second person or the break place in which the second person is on his or her break. In turning on the lamp, it is preferable to define, for example, a color or a blinking pattern in the lamp for each break place in advance, and turn on the lamp in the color or the blinking pattern that matches the break place in which the second person is on his or her break.

Note that the break notification is not limited to a notification using the visual sense. The notification unit 2040, for example, outputs a sound to the terminal used by the first person. An example of the sound is a predetermined sound such as a beep sound. When a beep sound or the like is used, it is preferable to specify a sound pattern for each break place in advance, and output a sound in the sound pattern associated with the break place in which the second person is on his or her break. When the terminal is implemented as the drinking vessel 10, the drinking vessel 10 is equipped with, for example, a loudspeaker that outputs a sound.

The sound output from the terminal used by the first person may be a voice message. In this case, even the voice message may include information that allows determination of the second person or the place in which the second person is on his or her break.

As another example, the notification unit 2040 may generate predetermined vibration in the terminal used by the first person. In this case, it is preferable to define a vibration pattern for each break place in advance, and generate vibration in the vibration pattern associated with the break place in which the second person is on his or her break. When the terminal is implemented as the drinking vessel 10, the drinking vessel 10 is further equipped with, for example, a vibration motor that generates vibration.

<<Notification to Second Person>>

When the second person is not a person staying in a break place, but a person determined to be in a suitable state for taking a break, the notification unit 2040 transmits a break notification to the second person as well. In this case, the break notification to be transmitted to the second person preferably includes information capable of identifying the first person.

When a plurality of break places are available, the information processing apparatus 2000 may determine a break place to allow the first person and the second person to take a break. In this case, the information processing apparatus 2000 includes information for identifying the determined break place into a break notification to be transmitted to each of the first person and the second person. As the break place to allow the first person and the second person to take a break, a place easily accessible by both the first person and the second person is preferably set. When, for example, the first person and the second person are at work on the same floor, a break place provided on this floor is preferably set as the break place used. As another example, the information processing apparatus 2000 may determine, as the break place to allow the first person and the second person to take a break, a break place closest to the midpoint between the location in which the first person is at work and that in which the second person is at work.

<Case Where Plurality of Second Persons Satisfying Predetermined Condition Exist>

A plurality of second persons satisfying the predetermined condition may exist. In this case, the information processing apparatus 2000 may allow all these second persons to take a break with the first person, or may allow only some of them to take a break with the first person. In the former case, the notification unit 2040, for example, sends a break notification to all the second persons satisfying the predetermined condition, or transmits a break notification including the information of each second person to the first person. In doing so, the break notification to be sent to each second person preferably includes information concerning other second persons.

When only some of the plurality of second persons satisfying the predetermined condition are to be allowed to take a break with the first person, the information processing apparatus 2000, for example, determines a person, having a highest priority level indicated by the association with the first person, as a second person recommended to take a break with the first person of the second persons satisfying the predetermined condition. The notification unit 2040 sends a break notification to the person determined as the second person recommended to take a break with the first person, or sends a break notification including information concerning this person to the first person.

The determination unit 2020, for example, handles a plurality of persons associated with the first person as second persons in descending order of priority level of association with the first person, until a second person satisfying the predetermined condition is detected. In other words, when the predetermined condition is satisfied for a certain second person, the determination unit 2020 does not perform determination processing for the remaining second persons. With this procedure, among the second persons satisfying the predetermined condition, a person having a highest priority level is handled as a person recommended to take a break with the first person.

Two or more persons, however, may be recommended to take a break with the first person. In this case, the determination unit 2020, for example, handles a plurality of persons associated with the first person as second persons in descending order of priority level of association with the first person, until the number of second persons satisfying the predetermined condition reaches a predetermined number. In other words, when the predetermined condition is satisfied for a predetermined number of second persons, the determination unit 2020 does not perform determination processing for the remaining second persons. With this procedure, among the second persons satisfying the predetermined condition, a predetermined number of persons are handled as persons recommended to take a break with the first person, in descending order of priority level. The notification unit 2040 sends a break notification to each of the predetermined number of second persons determined to satisfy the predetermined condition, or sends a break notification including information concerning each of the plurality of second person to the first person. In doing so as well, the break notification to be sent to each second person preferably includes information concerning other second persons.

### Second Example Embodiment

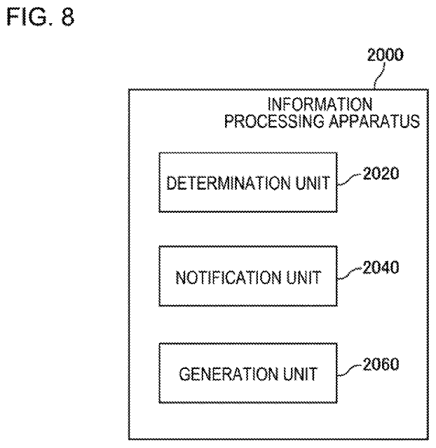

FIG. 8 is a block diagram illustrating the functional configuration of an information processing apparatus 2000 according to a second example embodiment. The information processing apparatus 2000 according to the second example embodiment has functions similar to those of the information processing apparatus 2000 according to the first example embodiment, except in the respects to be described hereinafter.

The information processing apparatus 2000 according to the second example embodiment includes a generation unit 2060 that generates association information. The generation unit 2060 acquires attribute information indicating the value of any attribute (referred to as the attribute value, hereinafter) of a person for each of a plurality of persons, and generates association information using the acquired attribute information.

As the attributes of a person, various attributes can be adopted. Examples of these attributes include the sex, the hometown, the joining year, the field of expertise, a worry, an interest or hobby, the age, the family composition, the school one went to, the position in the workplace, the kind of work one is involved in, a person with whom one has previously stayed in a break place, a room where one always is on duty, and a floor having a room where one always is on duty.

The generation unit 2060 computes, for all combinations of two persons acquired from a plurality of persons (for example, all members of the staff working in the same building), degrees of association representing the degrees to which the attribute values of these two persons are associated with each other, for one or more attributes. The generation unit 2060 generates association information using these degrees of association. The generation unit 2060, for example, generates association information associating persons having a high degree of association (for example, persons having a degree of association equal to or higher than a predetermined value) with each other.

A variety of methods are available to compute the degree of association based on the attribute value. For example, a method for computing the degree of association is specified in advance for each attribute. An arbitrary method is applicable to this specification, and the administrator of the information processing apparatus 2000, for example, decides this method, based on an empirical rule or the operational purpose (for example, the characteristics of persons to be encouraged to communicate with each other) of the information processing apparatus 2000. The degree of association of each attribute is computed as, for example, a value that is higher for a higher degree of similarity between attribute values. For persons to be compared with each other, for example, the degree of association is set higher as their hometowns are closer, or the degree of association is set higher as their joining years are nearer.

The degree of association, however, may be set higher as the degree of similarity between attributes is lower, depending on the attribute. When, for example, communication among men and women is to be activated, the degree of association may be set higher for persons of opposite sexes than for persons of the same sex. When, as another example, communication among persons specializing in different fields of expertise is to be activated, the degree of association may be set higher as the degree of similarity between the fields of expertise is lower.

The degree of association may even be computed by comparing the attribute values of different attributes with each other. For example, a worry of a certain person and the fields of expertise of other persons are compared with each other, and the degree of association is set higher as the degree to which the worry can be resolved by the field of expertise is higher.

Using the attribute “a person with whom one has previously stayed in a break place,” the degree of association between persons who have previously stayed in a break place together may be set high.

The computation of the degree of association may use only one of the attributes, or may use a plurality of attributes. In the latter case, the degree of association between persons is computed by, for example, statistically processing the degree of association computed for each of the plurality of attributes. The statistical processing can use, for example, a weighted average. The weight applied to each attribute may be manually determined by the administrator of the information processing apparatus 2000, or may be automatically determined by the information processing apparatus 2000. In the latter case, for example, a computation model for computing the degree of association is determined by machine learning. This machine learning can use, for example, feedback by a feedback unit 2080 (to be described later in the subsequent example embodiment). The feedback unit 2080 performs processing for updating the priority level of association between the first person and the second person. In view of this, the generation unit 2060 can improve the accuracy of an equation for computing the degree of association by performing machine learning while handling the updated priority level as a correct answer, degree of association.

<Details of Attribute Information>

A variety of methods are available to acquire attribute information. The information processing apparatus 2000, for example, generates attribute information of a person by extracting an attribute value from information that the person has entered in, for example, profile information. The profile information can be acquired by the person from, for example, an in-house site (an in-house personnel site or an in-house profile site), an in-house social networking service (SNS), or an in-house address book.

As another example, the information processing apparatus 2000 may generate attribute information by extracting attribute values from various texts created by a person. More specifically, attribute values are extracted by extracting keywords from, for example, a document in an in-house site, an e-mail message, a post on an in-house SNS, or a report. Note that attribute values may be extracted from speech. For example, words spoken by each person in a break place, a conference room, or the like are recorded as speech data. The information processing apparatus 2000 generates attribute information by extracting the attribute values of each person by performing speech recognition and keyword extraction for the speech data.

<Use of Degree of Association by Determination Unit 2020>

The degree of association computed between persons may be used as the priority level (the Priority level 206 illustrated in FIG. 7) of association between the persons. In this case, a plurality of persons associated with the first person are handled as second persons in descending order of degree of association with the first person.

<Exemplary Hardware Configuration>

The hardware configuration of a computer that implements the information processing apparatus 2000 according to the second example embodiment is depicted in, for example, FIG. 4, similarly to that according to the first example embodiment. The storage device 1080 of the computer 1000 that implements the information processing apparatus 2000 according to this example embodiment, however, further stores a program module for implementing a function of the information processing apparatus 2000 specific to this example embodiment.

### Advantageous Effect

The information processing apparatus 2000 according to this example embodiment determines association between persons, using the degree of association between the persons computed using the attribute values of the persons. This makes it possible to enhance the probability that persons having a high degree of association will take a break together.

### Third Example Embodiment

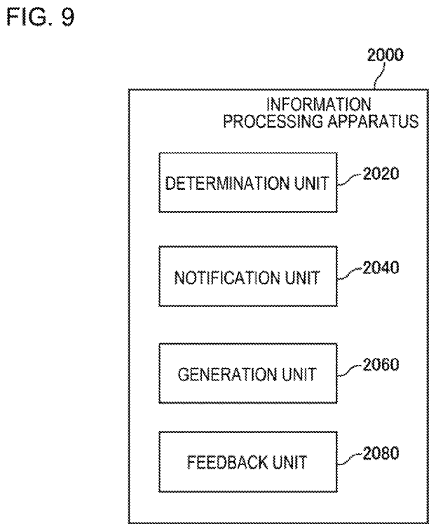

FIG. 9 is a block diagram illustrating the functional configuration of an information processing apparatus 2000 according to a third example embodiment. The information processing apparatus 2000 according to the third example embodiment has functions similar to those of the information processing apparatus 2000 according to the second example embodiment, except in the respects to be described hereinafter.

As described above, the information processing apparatus 2000 sends a break notification to enhance the probability that associated persons will take a break together. It is, however, not always appropriate to make the persons take a break together. Assume, for example, that certain persons have taken a break together using a break notification from the information processing apparatus 2000 as an opportunity, but their conversation has not got lively. In this case, these persons are expected to be less suitable for taking a break together. In another case, a first person having received a break notification from the information processing apparatus 2000 may not visit a break place. In this case, the first person may not have visited the break place after thinking that he or she does not want to take a break with a second person indicated by the break notification. On the other hand, as in the case where, for example, certain persons have taken a break together using a break notification from the information processing apparatus 2000 as an opportunity, and their conversation has got very lively, it may be preferable to further increase opportunities to allow these persons to take a break together.

In view of this, the information processing apparatus 2000 according to the third example embodiment includes a feedback unit 2080. The feedback unit 2080 updates the priority level of association between a first person and a second person, based on the situation after a break notification is sent in response to satisfaction of the predetermined condition for the first person and the second person.

The feedback unit 2080, for example, computes an index value representing the liveliness of conversation between the first person and the second person in a break place, after a break notification is sent to the first person by the notification unit 2040. The feedback unit 2080, for example, computes the amount of conversation (the length of the time spent in conversation) during the period in which the first person and the second person are staying in a break place, using a value detected by a sound pressure sensor placed in the break place, and uses the computed amount of conversation as an index value. As another example, the feedback unit 2080 may compute the time for which both the first person and the second person have stayed in a break place, and use the computed time as an index value.

The feedback unit 2080 updates the priority level of association between the first person and the second person, using the above-mentioned index value. The feedback unit 2080, for example, sets, as a new priority level to be indicated in the association information, the product of the priority level multiplied by the magnitude of the index value with respect to a reference value (index value divided by reference value). Note that the reference value is set in advance.

As another example, ranks are given to the magnitudes of the index values, and a correction factor for the priority level is set for each rank. In this case, the feedback unit 2080 computes a new priority level by determining a rank for the index value obtained for the first person and the second person, and multiplying the priority level by the correction factor associated with the rank.

<Exemplary Hardware Configuration>

The hardware configuration of a computer that implements the information processing apparatus 2000 according to the third example embodiment is depicted in, for example, FIG. 4, similarly to that according to the first example embodiment. The storage device 1080 of the computer 1000 that implements the information processing apparatus 2000 according to this example embodiment, however, further stores a program module for implementing a function of the information processing apparatus 2000 specific to this example embodiment.

### Advantageous Effect

The information processing apparatus 2000 according to this example embodiment updates the priority level of association between a first person and a second person, based on the situation after a break notification is sent in response to satisfaction of the predetermined condition for the first person and the second person. This makes it possible to enhance the probability that persons suitable for taking a break together will take a break together, by more accurately associating the persons with each other.

Example embodiments of the present invention have been described above with reference to the drawings, but they are merely illustrative examples of the present invention, and can adopt any combination of the above-described example embodiments, or various arrangements or configurations other than the foregoing.

Part or all of the above-described example embodiments may be described as in the following supplementary notes, but they are not limited thereto.

1. An information processing apparatus comprising:

determination unit acquiring state information representing states of persons regarding a first person and a second person, and determining whether a predetermined condition regarding states of the first person and the second person is satisfied by using state information of the first person and state information of the second person, the second person being associated with the first person in association information that associates persons with each other; and

notification unit sending, at least to the first person, a notification of recommending to take a break when a predetermined condition regarding the first person and the second person is satisfied.

2. The information processing apparatus according to 1, wherein

the predetermined condition is a condition in which a state of the first person is suitable for taking a break, and the second person is staying in a break place, and

the determination unit determines whether a state of the first person is suitable for taking a break by using state information of the first person, and determines whether the second person is staying in a break place by using state information of the second person.

3 The information processing apparatus according to 1,

wherein the predetermined condition is a condition in which states of both the first person and the second person are suitable for taking a break, and

the determination unit determines whether a state of the first person is suitable for taking a break by using state information of the first person, and determines whether a state of the second person is suitable for taking a break by using state information of the second person.

4. The information processing apparatus according to 3,

wherein when a predetermined condition is satisfied for the first person and the second person, the notification unit sends the notification to each of the first person and the second person.

5. The information processing apparatus according to 4,

wherein the association information indicates a priority level for association between persons, and

when there exist a plurality of second persons who are associated with the first person and are in a suitable state for taking a break, the notification unit determines the second person to which the notification is to be sent, from among the plurality of second persons, based on a priority level of association with the first person, and sends the notification to the determined second person.

6. The information processing apparatus according to any one of 1 to 5,

wherein the association information represents a priority level for association between persons, and

when there exist a plurality of persons associated with the first person, the determination unit handles, as the second person, each of the persons in descending order of a priority level of association with the first person.

7. The information processing apparatus according to 5 or 6, further comprising:

feedback unit updating a priority level of association between the first person and the second person, based on a state after the notification is sent in response to satisfaction of a predetermined condition regarding the first person and the second person.

8. The information processing apparatus according to any one of 1 to 7, further comprising:

generation unit acquiring attribute information indicating an attribute value for one or more attributes of a person, for each of a plurality of persons, and generating the association information by using the acquired attribute information.

9. The information processing apparatus according to 8,

wherein the generation unit computes a degree of association between persons by using an attribute value for each of a plurality of the persons, and generates the association information that associates persons with each other whose degree of association is equal to or larger than a predetermined value.

10. The information processing apparatus according to any one of 1 to 9,

wherein a drinking vessel equipped with an acceleration sensor is associated with a person, and

the determination unit determines a tilt of the drinking vessel based on a detection result acquired by the acceleration sensor of the drinking vessel associated with a person, and determines whether a state of the person is suitable for taking a break based on the determined tilt.

11. A control method performed by a computer, comprising:

determination step of acquiring state information representing states of persons regarding a first person and a second person, and determining whether a predetermined condition regarding states of the first person and the second person is satisfied by using state information of the first person and state information of the second person, the second person being associated with the first person in association information that associates persons with each other; and

notification step of sending, at least to the first person, a notification of recommending to take a break when a predetermined condition regarding the first person and the second person is satisfied.

12. The control method according to 11,

wherein the predetermined condition is a condition in which a state of the first person is suitable for taking a break, and the second person is staying in a break place, and

the determination step determines whether a state of the first person is suitable for taking a break by using state information of the first person, and determines whether the second person is staying in a break place by using state information of the second person.

13. The control method according to 11,

wherein the predetermined condition is a condition in which states of both the first person and the second person are suitable for taking a break, and

the determination step determines whether a state of the first person is suitable for taking a break by using state information of the first person, and determines whether a state of the second person is suitable for taking a break by using state information of the second person.

14. The control method according to 13,

wherein, when a predetermined condition is satisfied for the first person and the second person, the notification step sends the notification to each of the first person and the second person.

15. The control method according to 14,

wherein the association information indicates a priority level for association between persons, and

when there exist a plurality of second persons who are associated with the first person and are in a suitable state for taking a break, the notification step determines the second person to which the notification is to be sent, from among the plurality of second persons, based on a priority level of association with the first person, and sends the notification to the determined second person.

16. The control method according to any one of 11 to 15,

wherein the association information represents a priority level for association between persons, and

when there exist a plurality of persons associated with the first person, the determination step handles, as the second person, each of the persons in descending order of a priority level of association with the first person.

17. The control method according to 15 or 16, further comprising:

feedback step of updating a priority level of association between the first person and the second person, based on a state after the notification is sent in response to satisfaction of a predetermined condition regarding the first person and the second person.

18. The control method according to any one of 11 to 17, further comprising:

generation step of acquiring attribute information indicating an attribute value for one or more attributes of a person, for each of a plurality of persons, and generating the association information by using the acquired attribute information.

19. The control method according to 18,

wherein the generation step computes a degree of association between persons by using an attribute value for each of a plurality of the persons, and generates the association information that associates persons with each other whose degree of association is equal to or larger than a predetermined value.

20. The control method according to any one of 11 to 19,

wherein a drinking vessel equipped with an acceleration sensor is associated with a person, and

the determination step determines a tilt of the drinking vessel based on a detection result acquired by the acceleration sensor of the drinking vessel associated with a person, and determines whether a state of the person is suitable for taking a break based on the determined tilt.

21. A program for causing a computer to execute the steps of the control method according to any one of 11 to 20.

This application is based upon and claims the benefit of priority from Japanese Patent Application No. 2017-202393 filed on Oct. 19, 2017, the disclosure of which is incorporated herein in its entirety by reference.

What is claimed is:

1. An information processing apparatus comprising:
determination unit acquiring state information representing states of persons regarding a first person and a second person, and determining whether a predetermined condition regarding states of the first person and the second person is satisfied by using state information of the first person and state information of the second person, the second person being associated with the first person in association information that associates persons with each other; and
notification unit sending, at least to the first person, a notification of recommending to take a break when a predetermined condition regarding the first person and the second person is satisfied.

2. The information processing apparatus according to claim 1, wherein
the predetermined condition is a condition in which a state of the first person is suitable for taking a break, and the second person is staying in a break place, and
the determination unit determines whether a state of the first person is suitable for taking a break by using state information of the first person, and determines whether the second person is staying in a break place by using state information of the second person.

3. The information processing apparatus according to claim 1,
wherein the predetermined condition is a condition in which states of both the first person and the second person are suitable for taking a break, and
the determination unit determines whether a state of the first person is suitable for taking a break by using state information of the first person, and determines whether a state of the second person is suitable for taking a break by using state information of the second person.

4. The information processing apparatus according to claim 3,
wherein when a predetermined condition is satisfied for the first person and the second person, the notification unit sends the notification to each of the first person and the second person.

5. The information processing apparatus according to claim 4,
wherein the association information indicates a priority level for association between persons, and
when there exist a plurality of second persons who are associated with the first person and are in a suitable state for taking a break, the notification unit determines the second person to which the notification is to be sent, from among the plurality of second persons, based on a priority level of association with the first person, and sends the notification to the determined second person.

6. The information processing apparatus according to claim 1,
wherein the association information represents a priority level for association between persons, and
when there exist a plurality of persons associated with the first person, the determination unit handles, as the second person, each of the persons in descending order of a priority level of association with the first person.

7. The information processing apparatus according to claim 5, further comprising:
feedback unit updating a priority level of association between the first person and the second person, based on a state after the notification is sent in response to satisfaction of a predetermined condition regarding the first person and the second person.

8. The information processing apparatus according to claim 1, further comprising:
generation unit acquiring attribute information indicating an attribute value for one or more attributes of a person, for each of a plurality of persons, and generating the association information by using the acquired attribute information.

9. The information processing apparatus according to claim 8,
wherein the generation unit computes a degree of association between persons by using an attribute value for each of a plurality of the persons, and generates the association information that associates persons with each other whose degree of association is equal to or larger than a predetermined value.

10. The information processing apparatus according to claim 1,
wherein a drinking vessel equipped with an acceleration sensor is associated with a person, and
the determination unit determines a tilt of the drinking vessel based on a detection result acquired by the acceleration sensor of the drinking vessel associated with a person, and determines whether a state of the person is suitable for taking a break based on the determined tilt.

11. A control method performed by a computer, comprising:
acquiring state information representing states of persons regarding a first person and a second person, and determining whether a predetermined condition regarding states of the first person and the second person is satisfied by using state information of the first person and state information of the second person, the second person being associated with the first person in association information that associates persons with each other; and
sending, at least to the first person, a notification of recommending to take a break when a predetermined condition regarding the first person and the second person is satisfied.

12-20. (canceled)

21. A non-transitory computer readable storage medium storing a program for causing a computer to execute the control method according to claim 11.
